(19) United States
(12) Patent Application Publication
(10) Pub. No.: US 2018/0273344 A1
(43) Pub. Date: Sep. 27, 2018

(54) WIRE BRIDGE MONITORING SYSTEM

(71) Applicant: Inventio AG, Hergiswil (CH)

(72) Inventors: Christopher Mason, Ledgewood, NJ (US); Andrew Tadros, Bayonne, NJ (US); James Bibby, Wall Township, NJ (US)

(21) Appl. No.: 15/762,606

(22) PCT Filed: Sep. 21, 2016
(86) PCT No.: PCT/EP2016/072338

§ 371 Date: Mar. 23, 2018

(30) Foreign Application Priority Data
Sep. 23, 2015 (EP) 15186542.5

(51) Int. Cl. B66B 3/00

(52) U.S. Cl. CPC B66B 3/002; B66B 5/0031

(57) ABSTRACT

A wire bridge monitoring system includes a wire bridge (18) and a monitoring device (22, 24). The wire bridge (18) is used by a technician (20) during servicing an electrical or electro-mechanical installation (1) to bridge a component of the electrical or electro-mechanical installation (1). The wire bridge (18) has an electronic identification device (26) configured to transmit a radio signal (21) comprising an identification number of the wire bridge (18). The monitoring device (22, 24) has a transceiver (28, 37), a memory (23, 41) and a processor (31, 39). The transceiver (28, 37) receives the radio signal (21) transmitted by the electronic identification device (26) when within a predetermined radio range, and the memory (23, 41) records use of the wire bridge (18). The processor (31, 39) monitors if the wire bridge (18) is within the predetermined radio range, and generates an alarm if the wire bridge (18) is not within the predetermined radio range and the wire bridge (18) is recorded as being in use.

### FIELD

The various embodiments of a technology described herein generally relate to electrical or electro-mechanical installations that are subject to service or repair during which components of such installations need to be bypassed. More particularly, the various embodiments described herein relate to wire bridges used to bypass components in an electrical or electro-mechanical installation and to monitor use of these wire bridges.

### BACKGROUND

One example of an electrical or electro-mechanical installation is an elevator installation. Multi-story buildings are usually equipped with at least one elevator installation. In a generally known elevator installation, a suspension medium—such as a rope or flat belt-type rope—interconnects a counterweight and a car, and an electrical drive motor causes the suspension medium to move in order to thereby move the counterweight and the car up and down along a shaft or hoistway. An elevator controller of the elevator installation controls and monitors the operation of the elevator installation, e.g., by processing input signals received via communications network or signaling lines (e.g., from sensors, safety components (e.g., stop switches, door lock switches), etc.) and by generating control signals, which are fed to the communications network or the signaling lines.

An elevator installation is subject to regular servicing, maintenance, testing or occasional repairs. During these procedures, wire bridges or jumpers may be used to bypass, short circuit, or interrupt certain components, e.g., a safety door switch to allow operation of the elevator installation with an unlocked door, or a stop switch to allow a car to travel beyond a set stop. Once these procedures are finished, it is important that a technician removes all wire bridges, otherwise serious safety hazards exist. To minimize the risks caused by a jumper that has mistakenly been left in place, Wurtec, Inc., Ohio, USA, offers an electronic jumper that “times out” after a pre-programmed period of time. A jumper that times out is described in US 2009/0121731. Another approach is disclosed in WO 2011/090665, which describes an elevator safety tool for short circuiting an elevator switch. The tool includes a control module, and a relay, wherein the relay has a switch having a closed position and an open position. The control module receives status data and determines whether the operating status is “normal” or “service”. The switch is closed when the elevator is in service, and open when the elevator is in normal operation.

Even though these approaches reduce the risk caused by a “forgotten” jumper, the time-out functionality of such a jumper may not be sufficient to satisfy industry-standard safety requirements, especially when used for an extended period of time. Also, the elevator safety tool requires a technician not only to connect the tool to the switch to be short circuited, but also to the elevator control to receive status data. There is, therefore, a need for an alternative technology that further reduces the potential risks associated with using jumpers in electrical or electro-mechanical installations, such as an elevator installation, yet is simple to use for a technician in the field.

### SUMMARY

Accordingly, one aspect of such an alternative technology involves a monitoring system having a wire bridge and a monitoring device. The wire bridge is used by a technician during servicing an electrical or electro-mechanical installation to bridge a component of the electrical or electro-mechanical installation. The wire bridge has an electronic identification device configured to transmit a radio signal comprising an identification number of the wire bridge. The monitoring device has a transceiver, a memory and a processor. The transceiver receives the radio signal transmitted by the electronic identification device when within a predetermined radio range, and the memory records use of the wire bridge. The processor monitors if the wire bridge is within the predetermined radio range, and generates an alarm if the wire bridge is not within the predetermined radio range and the wire bridge is recorded as being in use.

Another aspect of the alternative technology involves a method of monitoring use of a wire bridge. In that method, a radio signal comprising an identification number of the wire bridge is received from the wire bridge when within a predetermined radio range. Based on the received radio signal, the method records that the wire bridge is used by a technician during servicing an electrical or electro-mechanical installation. The radio signal is monitored to determine if the wire bridge is still within the predetermined radio range. An alarm is generated if the wire bridge is not within the predetermined radio range and the wire bridge is recorded as being in use. The alarm is communicated to the technician using a monitoring device assigned to the technician.

The technology provides for an electronic wire bridge monitoring system that allows use of a wire bridge to be logged and tracked. According to that technology, a technician can generally position a wire bridge in an installation just like in the prior art, but without having to install or connect additional equipment or connections. As each wire bridge is provided with and wirelessly transmits a unique identifier, monitoring the use of the wire bridge occurs in a simple manner by means of a monitoring device.

In one embodiment, the monitoring device is included in a mobile device assigned to the technician. It may be a smartphone, a tablet computer, a portable computer, or an electronic service tool. These devices have a processor, a transceiver to receive and transmit data, and some kind of memory. The technician usually brings such devices to a site, so that the technician in one embodiment is not required to bring an additional tool to the site.

In another embodiment, the monitoring device includes the mobile device and a wire bridge kit. The wire bridge kit has a housing to receive several wire bridges and a transceiver. The transceiver detects removal and return of a wire bridge from the housing. Data relating to these events is recorded to allow logging and tracking of a wire bridge's use. The data may be stored in a memory of the wire bridge kit, the mobile device and/or a remote log server. The log server may be viewed as being part of a decentralized monitoring device, wherein communications occur via a network.

The alarm may be generated in various ways. For example, generating the alarm may include generating a warning message (e. g., a text message (SMS)), a visible alarm (e. g., an activated light source), an audible alarm and/or a vibrational alarm. This allows adapting the alarm mechanism to particular circumstances (e. g., noisy environments) and preferences of the technician.

In one embodiment, usage data is stored to allow monitoring (including logging and tracking) the use of the wire bridge. The usage data may include the identification number, a location of where the wire bridge is used, date and time of its use, and/or a location of the monitoring device. Depending on a particular embodiment, the usage date may be stored in a memory of the mobile device, the wire bridge kit and/or the log server.

The described technology allows flexibility as to the communications technology used. That is, Bluetooth technology or RFID technology may be used. In one embodiment, the electronic identification device includes a Bluetooth beacon and the transceiver includes a Bluetooth module. In another embodiment, the electronic identification device includes an RFID tag and the transceiver includes an RFID reader.

In one embodiment, the alarm may be sent to a remote control center. The technician's supervisor is in communication with the control center and is made aware of the alarm. In case the technician does not confirm the alarm, either by confirming removal of a forgotten wire bridge or explaining its prolonged use, at least the supervisor can attend to the alarm. This contributes to maintaining the installation in a safe and reliable state.

### DESCRIPTION OF THE DRAWINGS

The novel features and method steps characteristic of the technology are set out in the claims below. The various embodiments of the technology, however, as well as other features and advantages thereof, are best understood by reference to the detailed description, which follows, when read in conjunction with the accompanying drawings, wherein:

FIG. 1 shows a schematic illustration of an exemplary application of a wire bridge monitoring system in connection with an elevator installation;

FIG. 2 is a schematic illustration of a mobile device running a jumper software application;

FIG. 3 is a flow diagram of one embodiment of a method of operating the wire bridge monitoring system;

FIG. 4 is a schematic illustration of one embodiment of a jumper kit for use in one embodiment of the wire bridge monitoring system of FIG. 1;

FIG. 5 is a schematic illustration of interactions between components of in accordance with one embodiment of the wire bridge monitoring system; and

FIG. 6 is a flow diagram of a further embodiment of a method of operating the wire bridge monitoring system.

### DETAILED DESCRIPTION

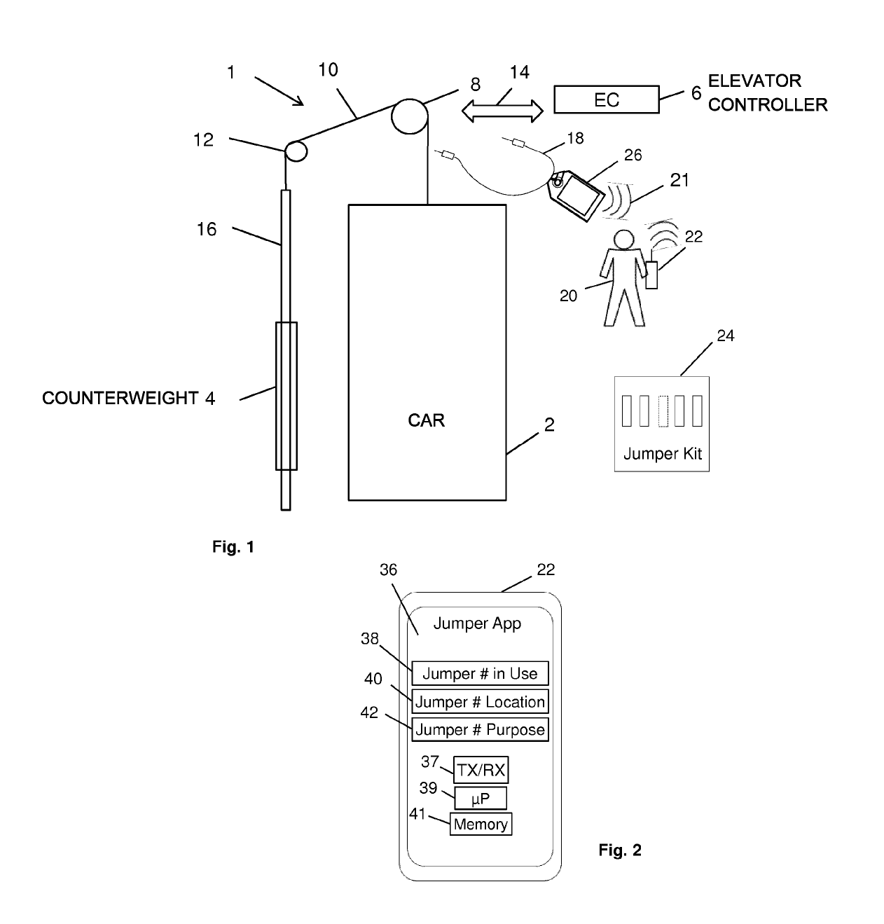

FIG. 1 schematically illustrates one exemplary application of a wire bridge monitoring system in connection with an elevator installation 1. A wire bridge used in the wire bridge monitoring system may hereinafter be referred to as a jumper. It is contemplated, however, that a wire bridge or jumper can bridge, bypass, short circuit, or jump components. The terms “bridge,” “short circuit,” “bypass,” and “jump” are used herein interchangeably. Further, the wire bridge monitoring system's use in not limited to elevator installations, but has general applicability in any electronic or electro-mechanical system or installation (including, e. g., vehicles (cars, trains), industrial installations, escalators, power control systems used, e. g. in utilities, etc.) subject to service, maintenance, testing or repair during which components need to be bypassed or bridged, and in which a wire bridge (i.e., a jumper) left in place may cause a safety hazard. With that in mind, details of various embodiments of the wire bridge monitoring system and its operation are described herein with reference to the elevator installation 1 shown in FIG. 1.

Briefly, the elevator installation 1 of FIG. 1 is, e.g., installed in a multi-story building, whereas individual floors are not shown in FIG. 1. The elevator installation 1 includes a car 2 connected via a suspension medium 10 (e.g., one or more round ropes or flat belt-type ropes) to a counterweight 4, wherein the car 2 and the counterweight 4 are movable up and down in opposite directions in a vertically extending shaft or hoistway (not indicated in FIG. 1). In the situation shown in FIG. 1, a jumper 18 of the wire bridge monitoring system is coupled to the elevator installation 1 and available for use in accordance with the embodiments described herein. For example, a technician 20 may have installed the jumper 18 to temporarily overcome a problem at the elevator installation 1. In that case, the technician 20 already installed the jumper 18 at a desired location to bridge a component of the elevator installation 1. The technician 20 may keep the jumper 18 in a tool box. In one embodiment described below, the technician 20 may keep several jumpers 18 in a jumper kit 24, which is portable so that the technician 20 may carry it from one elevator installation 1 to another. In addition to the tool box and/or the jumper kit 24, the technician 20 carries a mobile device 22, e.g., a smartphone, a tablet PC, a laptop, a PDA, or another portable electronic device that assists the technician 20 to service the elevator installation 1.

The exemplary elevator installation of FIG. 1 has guide rails for both the car 2 and the counterweight 4. For ease of illustration, FIG. 1 shows a guide rail 16 for the counterweight 4 only, but not for the car 2; however, it is contemplated that the car 2 is guided by at least one guide rail as well. A drive 8 is coupled to the suspension medium 10 and configured to act upon the suspension medium 10 to move the car 2 and the counterweight 4. Next to the drive motor 8, a deflection sheave 12 is positioned above the counterweight 4 to deflect the suspension medium 10 between the drive 8 and the counterweight 4, as shown in FIG. 1, so that the car 2 and the counterweight 4 can move along different paths without colliding. An elevator controller 6 (in FIG. 1 labeled as EC) of the elevator installation 1 interacts with various components of the elevator installation 1 (e.g., the drive motor 8, car and landing operating panels, and safety chain components) via a communications network and/or signaling lines; these interactions and communications means are represented in FIG. 1 through a double arrow 14. The elevator controller 6 is configured to control and monitor the performance and operation of the elevator installation 1, as is known in the art.

The jumper 18 illustrated in FIG. 1 is provided with an electronic identification device 26 (hereinafter referred to as “ID device 26”). The ID device 26 includes in the illustrated embodiment a transmitter for electromagnetic waves and an associated electronic circuitry, e. g., to store data. In certain embodiments, the ID device 26 may be adapted for wireless communication technologies, such as RFID (radio frequency identification) or Bluetooth applications. In either of these exemplary configurations, the ID device 26 may be a label or a tag attached (e.g., glued or tied) to the jumper 18. The general functionalities of these technologies are known to one of ordinary skill in the art; they are described herein only to the extent believed to be helpful for a full understanding of the technology described herein.

Adapted for RFID technology, the ID device 26 includes a memory chip and an RFID transponder, which may be active (i. e., it has an internal power supply (e. g., a battery)) or passive (i. e., it requires external supply of power). Such an ID device 26 may be referred to as RFID tag. The memory chip stores data that identifies the jumper 18; the data may include a unique identification (ID) number. Upon activation by an RFID reader, e. g., as part of the mobile device 22, transmitting a polling signal, the RFID transponder within radio range responds by retrieving and transmitting the stored data. If a passive RFID transponder is used, the polling signal powers the RFID transponder. For such polling, a polling cycle may be defined for the RFID reader, wherein the polling cycle begins as soon as the technician 20 uses the jumper 18 and activates the mobile device 22, as described below. It is contemplated that polling may also be initiated by the technician 20, e. g., to locate the jumper 18 (which may then vibrate or sound). If the ID device 26 of the jumper 18 and the RFID reader are within radio range, the RFID reader receives the ID number via a radio communications link existing between them.

Adapted for Bluetooth technology, the ID device 26 includes a Bluetooth beacon. The communications between such a beacon and, e. g., a mobile device 22 with a Bluetooth module occur according to a Bluetooth standard, e. g., Bluetooth Standard 4.0 (Bluetooth Low Energy (BLE)) or any other Bluetooth standard. The beacon usually includes a battery operated transmitter that permanently transmits in short intervals of about 1 second a unique identification number (e. g., “ID=5”). If the beacon 26 and the mobile device 22 are within radio range, the mobile device 22 receives the beacon's identification number via a radio communications link existing between them. Correspondingly, once they are out of radio range, a radio communications link does not exist.

One example of a Bluetooth beacon is an Enterprise Beacon available from Onyx Beacon Ltd., Romania. Such a beacon has a buzzer to emit an audible signal. Another example is a so-called iBeacon from Apple, Inc., USA.

FIG. 2 is a schematic illustration of a mobile device 22 as one example of a monitoring device used by the technician 20 of FIG. 1. In the illustrated embodiment, the mobile device 22 is a smartphone having a display 36, a processor 39, a memory device 41, and a transceiver 37 for communications within a cellular communications system. Such a smartphone generally operates as is known in the art, e. g., it allows communications via voice, video, and/or text (e. g. using SMS (Short Messages Service)), and use of installed software applications (in singular form referred to as “app”) for various purposes, such as position information via the global positioning system (GPS). For illustrative purposes, FIG. 2 depicts an exemplary view generated by a jumper app for use with the technology described herein. The view includes various fields 38, 40, 42: field 38 shows which jumper 18 is currently in use, field 40 shows where it is located (installed), and field 42 explains its purpose. It is contemplated that the view depicted in FIG. 2 is merely an example and that the jumper app may generate other configurations of the view and/or several pages for various features of the jumper app.

For example, a main page may be presented when the jumper app starts. The main page requires the technician 20 to log in, e. g., by inputting a password and/or an email address. Another page may allow the technician 20 to specify a maximum distance between the mobile device 22 and the jumper 18, and to specify an alarm type, e. g., vibration, message, audio, and/or light. The maximum distance defines a predetermined radio range; if the distance between the mobile device 22 and the jumper 18 is greater than the maximum distance, the jumper 18 is deemed out of range. If the jumper 18 is in use, the jumper app generates an alarm according to the specified alarm type.

In one embodiment, the mobile device 22 is equipped with a Bluetooth module. Such a Bluetooth module is a standard equipment of a smartphone, and enables communications with other Bluetooth enabled devices, such as a Bluetooth enabled ID device 26 of the jumper 18. Using the display 36, the technician 20 can enable or disable the Bluetooth module. In another embodiment, the mobile device 22 is equipped with an RFID reader. In one embodiment, such an RFID reader may be configured as an attachment to a smartphone. In such a configuration, the mobile device 22 includes an RFID reader and a Bluetooth module.

In one embodiment, the memory 41 stores usage data of the jumper 18, such as the identification number, a location of where the jumper 18 is used, date and time of its use, and a location of the mobile device 22. Some of that data may be entered by the technician 20, e. g., via the jumper app. The location data may be automatically entered using the GPS system of the mobile device 22.

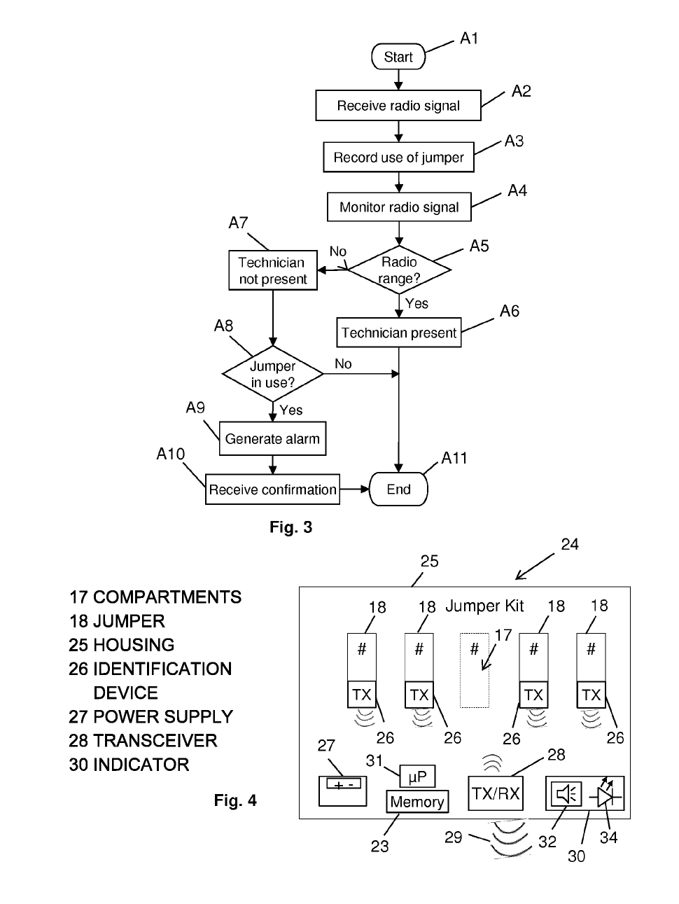

With the understanding of the general structure of the wire bridge monitoring system and certain features of its components described with reference to FIG. 1-FIG. 2, a description of how one embodiment of the wire bridge monitoring system operates follows with reference to FIG. 3. FIG. 3 shows a flow diagram of one embodiment of a method of operating the wire bridge monitoring system. It is assumed that the technician 20 is at the site of an elevator installation 1 with the technician-carried mobile device 22 running the jumper app. It is contemplated that in another illustration some of the shown steps may be merged into a single step, and a step may be split into two or more steps. The flow diagram starts at a step A1 and ends at a step A11.

Proceeding to a step A2, the method receives a radio signal 21 comprising the jumper's ID number from the jumper 18 when within the predetermined radio range. If the radio signal 21 is received, e. g., by the mobile device 22, the technician 20 is in proximity of the jumper 18. The technician 20 may still handle the jumper 18 to prepare its installation, or may have already installed the jumper 18 and work in its proximity.

Proceeding to a step A3, the method records use of the wire bridge 18 by the technician 20. The use may be recorded in a log file maintained, e. g, in the mobile device's memory 41. The use is based on the received radio signal 21 because, e. g., once the technician 20 is done inputting data regarding the use of the jumper 18, receipt of the radio signal 21 is considered to be the beginning of the jumper's use. Depending on a particular embodiment, the jumper app may display a signal strength of the received radio signal 21 and, e. g., a charge state if a battery-powered Bluetooth beacon or an active RFID tag is used.

Proceeding to a step A4, the method monitors the radio signal 21. In one embodiment, the mobile device 22 may monitor the received signal strength as a function of time to determine if the jumper 18 remains within the predetermined radio range. As mentioned above, the mobile device 22 receives the radio signal 21 as long as the technician 20 is in proximity of the jumper 18, i. e., while the distance between them is less than the predetermined maximum distance.

Proceeding to a step A5, if the method determines that the jumper 18 is within the predetermined radio range, the method proceeds along the Yes branch to a step A6. In step A6, the method determines that the technician 20 is present and that, therefore, no potentially critical situation exists regarding the use of the jumper 18. If the technician 20 no longer needs the jumper 18, the technician is supposed to remove the jumper 18 and to use the jumper app to check the jumper 18 in. After such check in, the log file is updated and the jumper 18 is no longer recorded as being used. The method ends in step A11.

If in step A5 the method determines that the jumper 18 is not within the predetermined radio range, the method proceeds along the No branch to a step A7. In step A7, the method determines that the technician 20 is not present. For example, the technician 20 may have left the site for the day, or may have temporarily left the immediate vicinity of the jumper 18.

Proceeding to a step A8, the method determines if the jumper 18 is still recorded as being used. For example, if the technician 20 properly checked in the jumper 18 after its use, the log file no longer shows the jumper 18 as being used. In that case, the absence of the technician 20 is not critical and regarding the monitoring of the jumper use all is in order. The method proceeds along the No branch to the end at step A11.

If in step A8 the method determines that the jumper 18 is recorded as being used, a critical situation may exist because the jumper 18 is still in use, but the technician 20 is no longer present. For example, the technician 20 may have forgotten to remove the jumper 18 at the end of the service. In that case, the method proceeds along the Yes branch to a step A9.

In step A9, the method generates an alarm. In one embodiment, the alarm is communicated to the technician 20 using the mobile device 22. The mobile device 20 may display a text message, alone or in combination with symbols or light effects, vibrate, generate an audio message, or a combination thereof. In one embodiment, the alarm may be communicated to the technician's supervisor, e. g., in a manner that corresponds to the manner the alarm is communicated to the technician 20, for example, via a mobile device assigned to the supervisor.

Proceeding to a step A10, the method determines if the alarm is confirmed. The alarm requires a response or action either by the technician 20 or the supervisor. For example, if the technician 20 forgot to remove the jumper 18, the technician 20 is required to confirm that the jumper 18 has been removed, or will be removed shortly. In some situations it may be justified to leave the jumper 18 in place. In such a situation, however, the technician 20 may be required to report a justification, if any, for leaving the jumper 18 on site to the supervisor. The supervisor may accept such an explanation and disable the alarm.

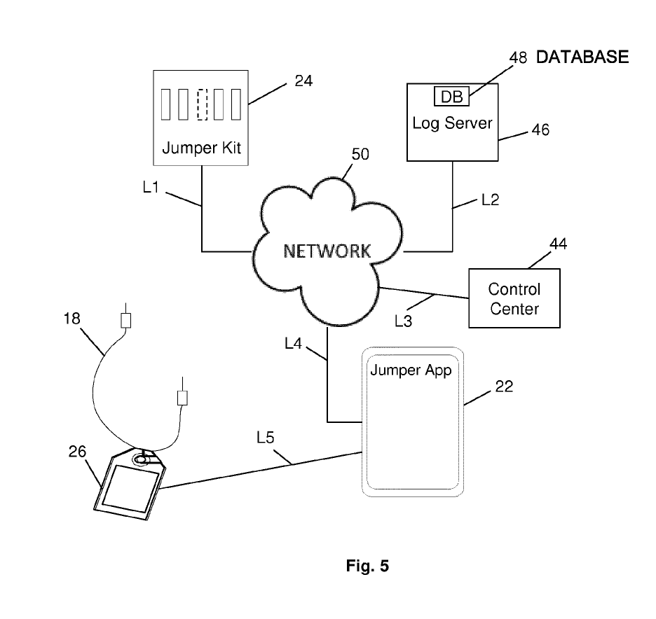

In one embodiment, several jumpers 18 may be organized in a jumper kit 24. FIG. 4 is a schematic illustration of one embodiment of the jumper kit 24 used in one embodiment of the wire bridge monitoring system. The jumper kit 24 has a housing 25 sized to receive several jumpers 18, for example, either loosely disposed or ordered in numbered compartments 17. The jumpers 18 may be numbered or otherwise labeled to allow visual identification and verification. In the example of FIG. 4, the housing 25 includes five jumpers 18, whereas one jumper 18 has been removed (for illustrative purposes illustrated via dashed lines). In addition, or in the alternative, each jumper 18 is provided with an electronic identification device 26, as described above. For illustrative purposes, the ID device's transmitter is in FIG. 4 labeled as TX. The jumper kit 24 includes further a transceiver 28 (in FIG. 4 labeled as TX/RX), a power supply 27 (e. g. a battery), a memory 23, a processor 31, and an indicator 30, which are arranged in the housing 25. Depending on a particular embodiment, the indicator 30 may include at least one of a loudspeaker or buzzer 32, a light source 34 (e. g., an LED), or a display (e.g., an LCD display).

The jumpers 18 and the transceiver 28 communicate with each other using wireless technology. Examples of such wireless technology are the RFID technology and the Bluetooth technology, as described above. If the ID device 26 of the jumper 18 and the transceiver 28 are within radio range, the transceiver 28 receives the ID number via a radio communications link existing between them. As the transceiver 28 receives a response from each jumper 18 present in the jumper kit 24 any “missing” jumper 18 can be identified.

As indicated by a symbol for a radio wave 29, the transceiver 28 not only communicates with the jumpers 18 of the jumper kit 25, but also with one or more other entities, as described below with reference to FIG. 5. At least some of the entities may be located at remote locations, beyond the radio range for a wireless communication. To allow communications with such remotely located entities, the transceiver 28 may have a radio module to access a WiFi network or a cellular communications network.

The jumper kit 24 and, hence, its jumpers 18 may be assigned to the technician 20. For that purpose, the jumper kit 24 may have a number or code, e. g., a visible code or number on an outer surface, or an electronic number or code stored in the memory 23 coupled to the transceiver 28. In the latter case, the transceiver 28 can retrieve and transmit that number or code according to a preset schedule or in response to a received request. It is contemplated that the memory 23 may further store usage data, e. g., such as described above with reference to the memory 41.

FIG. 5 is a schematic illustration of interactions between components used in connection with one embodiment of the wire bridge monitoring system. Depicted are the jumper 18, its ID device 26, the jumper kit 24, the mobile device 22, a log (or logging) server 46 and a control center 44. The log server 46 is a computer especially configured to maintain a log file that records events and processes occurring in the wire bridge monitoring system. The log file may be stored in a database 48. In the technology described herein, exemplary events are the removal of a jumper 18 from the jumper kit 24, and its return. Associated with these events, the log file includes the ID of the jumper 18 (hereinafter referred to as jumper ID), and the identification of the technician 20 to which the jumper 18 is assigned. Each event or process is recorded with a time stamp (date and time).

The log server 46 may be maintained by the company that installed the elevator installation 1 and/or services the elevator installation 1. Its database 48 maintains records with details regarding serviced elevator installations 1 (e. g., locations, service records), names of its technicians 20, their contact information (e. g., device numbers or phone numbers of their mobile devices 22, or e-mail addresses), jumper kits 24 assigned to the technicians 20, IDs of the jumpers 18 assigned to each jumper kit 24. For example, if the ID of a jumper 18 is known, the database 48 allows identification of the jumper kit 24 to which this jumper 18 belongs and to which technician 20 the jumper kit 24 is assigned.

The control center 44 represents in one embodiment, a computing device of the technician's supervisor. The computing device may be also a mobile device, such as a smartphone, or a stationary computer at a service headquarters.

Also shown in FIG. 5 is a communications network 50 that allows communications between at least some of these components. The communications network 50 may include a LAN, a WAN, the internet, which may include wired or wireless networks, and/or a cellular communications network for mobile communications, such as for UMTS or 4G. In the illustration of FIG. 5, a communications link L1 may exist between the jumper kit 24 and the communications network 50, a communications link L2 may exist between the log server 46 and the communications network 50, a communications link L3 may exist between the control center 44 and the communications network 50, and a communications link L4 may exist between the mobile device 22 and the communications network 50. Another communications link L5 may exist between the mobile device 22 and the ID device 26 of the jumper 18.

Referring to FIG. 4 and FIG. 5, if the transceiver 28 detects, for example, that a jumper 18 is removed, that event is communicated to the log server 46 via the communications links L1, L2. Depending on a particular embodiment, that event may also be reported to the technician's supervisor via the communications links L1, L3. Corresponding communications take place when the jumper 18 is returned to the jumper kit 24.

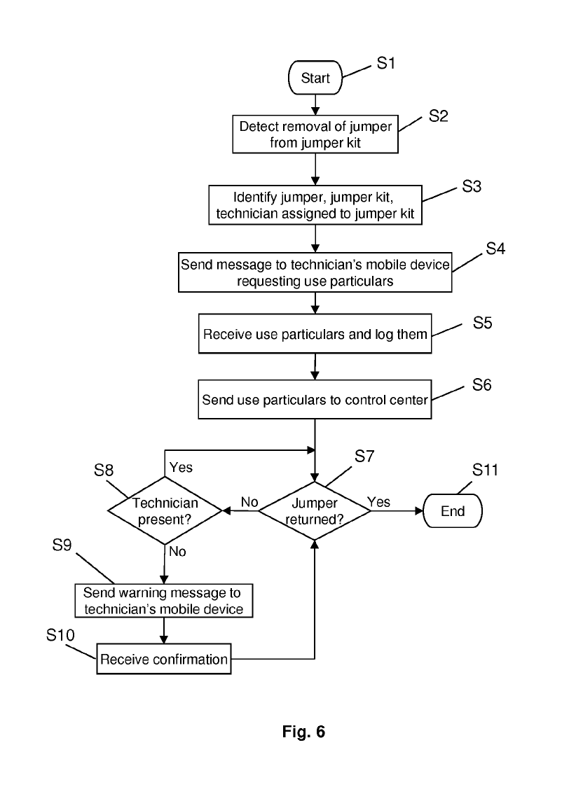

FIG. 6 shows a flow diagram of one embodiment of a method of operating the wire bridge monitoring system, in which the jumper kit 24 of FIG. 4 is used. It is assumed that the technician 20 is at the site of an elevator installation 1 with the jumper kit 24 assigned to the technician 20 being in an active mode and the technician-carried mobile phone 22 running the jumper app. It is contemplated that in another illustration some of the shown steps may be merged into a single step, and a step may be split into two or more steps. The flow diagram starts at a step S1 and ends at a step S11.

Proceeding to a step S2, the method includes detecting removal of a jumper 18 from the jumper kit 24. When the technician 20 removes the jumper 18, and ultimately installs it in the elevator installation 1, the jumper 18 is no longer within radio range of the transceiver 28, and the transceiver 28 detects that that particular jumper 18 (e. g., with “ID=5) is no longer in the jumper kit 24. In one embodiment, the indicator 30 shown in FIG. 2 indicates the absence of the jumper 18 either visually or acoustically. The transceiver 28 still receives the IDs of the remaining jumpers 18 in the jumper kit 24. The detected absence of the jumper 18 triggers a logging mechanism, which includes sending the ID of the removed jumper 18 to the logging server 46 by the transceiver 28, e. g., via the communications links L1, L2 of FIG. 4. In one embodiment, the transceiver 28 is set up to initiate such sending automatically as soon as a change of the number of received jumper IDs is detected.

In one embodiment, while the technician 20 handles the jumper 18 or works in close proximity of the jumper 18, the communications link L5 shown in FIG. 5 exists between the mobile device 22 and the jumper 18. The jumper app detects the communications link L5, and, hence the closeness of the jumper 18 (e. g., with “ID=5”) to the mobile device 22.

Proceeding to a step S3, the method includes identifying, by the log server 46, the jumper ID sent by the transceiver 28. A software program being executed in the log server 46 uses the jumper ID to access the database 48 and retrieve information that identifies the jumper kit 24 to which the jumper ID is assigned and the technician 20 to which the jumper kit 24 is assigned. With the technician 20 being identified, the technician's contact information (e. g., phone number) is available as well.

Proceeding to a step S4, the method includes sending a message to the technician's mobile device 22. The message may be a text message (e. g., based on the Short Message Service (SMS)) sent to the phone number (e. g. obtained in the step S3) assigned to the mobile device 22. The text message requests the technician 20 to provide use particulars for the jumper 18, e. g., location and purpose of the use. In one embodiment, the message may start the jumper app which then requests input of the use particulars from the technician 20, e. g., via the fields 40, 42 shown in FIG. 3.

Proceeding to a step S5, the method includes receiving use particulars. For example, the jumper app may prompt the technician 20 to enter the location of the jumper 18 via the field 40, and to specify its purpose via the field 42. As mentioned above, the mobile device 22 may receive the jumper ID directly from the jumper 18. In that case, the jumper app may automatically provide the jumper ID to the field 38. In the alternative, the jumper ID may be entered by the technician 20. Once these use particulars are provided, the jumper app causes the mobile device 22 to send the use particulars to the log server 46 where it is logged.

Proceeding to a step S6, the method includes sending the use particulars received in step S5 to the control center 44. As mentioned above, the control center 44 is in one embodiment a computing device of the technician's supervisor. It is contemplated that in certain embodiments it may not be necessary or desired to inform the supervisor, but the jumper use would still be logged at the control center and that, therefore, step S6 may be omitted. In that case, the monitoring function by the supervisor is disabled. The situations that allow such disabling may be defined by an administrator of the application.

Proceeding to a step S7, the method checks if the jumper 18 has been returned to the jumper kit 24. In one embodiment, that checking is performed by the log server 46 at regular intervals. The software program of the log server 46 monitors the status of the jumper 18 recorded in the log file. For example, a jumper 18 that is currently in use may be considered to having a status “in use”. At the end of the service, the technician 20 is supposed to remove the jumper 18 from the elevator installation 1 and to return it to the jumper kit 24. As soon as the jumper 18 is in the jumper kit 24, the transceiver 28 detects its presence and sends a message with the jumper ID to the log server 46. The log server 46 records the return of the jumper 18 and sets the jumper's status to “not in use.” The method then proceeds along the Yes branch to the end of the method in step S11.

If, however, the jumper 18 is not returned, the log server 46 will continue showing the jumper 18 with a status “in use,” i. e., as being used at the previously specified location in the elevator installation 1 by the technician 20. In that case, the method proceeds along the No branch to a step S8.

Referring to step S8, the method includes determining if the technician 20 is still on site, which is an indication of whether or not the technician 20 finished servicing the elevator installation 1. In one embodiment, the method verifies if the communications link L5 shown in FIG. 5 still exists between the mobile device 22 and the jumper 18. If this is the case, the technician 20 is still working in close proximity of the jumper 18 and not yet done servicing the elevator installation 1. The method is in a waiting loop along the NO branch back to step S7 until the service is done. If, however, the communications link L5 no longer exists, it is assumed that the technician 20 is no longer on site and may have finished the service. The method proceeds along the No branch to a step S9.

As an alternative to verifying if the communications link L5 still exists between the mobile device 22 and the jumper 18, the (GPS) positioning system of the mobile device 22 may be used to monitor the location of the technician 20. The positioning system may not be precise enough to determine if the technician 20 is in close proximity of the jumper 18, but sufficiently precise to determine whether or not the technician 20 is still at the site of the elevator installation 1.

Referring to the step S9, the method sends a warning message to the technician's mobile device 22 and possibly the supervisor. The warning message is sent to clarify a potentially critical situation: the technician 20 is no longer on site (see step S8) and the jumper 18 has not been returned (see step S7). The message may be presented to the technician 20 via a text message or the jumper app. The message informs the technician 20 that the jumper 18 has not yet been returned to the jumper kit 24. Further, the message requires the technician 20 to return the jumper 18 or to explain why it is still in use, e. g., via the jumper app or a phone call with the supervisor.

In one embodiment, a message is also sent to the jumper kit 24 to activate the indicator 30. This may serve as an additional measure to remind the technician 20 of the missing jumper 18.

In one embodiment, a corresponding warning message may also be sent to the control center 44 to inform the technician's supervisor. Sending the warning message to the control center 44 is an additional safety measure that ensures other persons are made aware of the potentially critical situation just in case the technician 20 does not receive the warning message or cannot act upon it.

Proceeding to a step S10, the method receives a confirmation regarding the warning message sent in step S9. The warning message requires a response or action either by the technician or the supervisor. For example, the technician 20 may be required to report back the justification, if any, for leaving the jumper 18 or the jumper kit 24 on site. If the technician 20 forgot to remove and return the jumper 18, the technician 20 is required to confirm that the jumper 18 has been returned or will be removed and returned shortly. In that case, the method proceeds to step S7 and will detect the return of the jumper 18, as described above. In the illustration of FIG. 5, the method also proceeds to step S7 if the technician 20 explains the prolonged use of the jumper 18. The supervisor may accept such an explanation and set the status of the jumper 18 to “not in use” in the log file so that the jumper 18 is deemed to have been returned in step S7.

It is apparent that there has been disclosed a technology for bypassing components of an electrical or electro-mechanical installation that fully satisfy the objects, means, and advantages set forth herein before. For example, logging and tracking the use of a jumper 18 reduces the potential risks associated with a jumper 18 being left in place after servicing the installation. In one embodiment (see FIGS. 1, 2 and 3), monitoring the jumper's use is performed centralized (or local) through the monitoring device of the mobile device 22 and its interactions with the jumper 18. In another embodiment (see FIGS. 1, 4 and 5), monitoring the jumper's use is performed decentralized further involving the log server 46.

In either one of these monitoring schemes, the monitoring device and the associated jumper app running on the mobile device 22 can be configured for certain functionalities that further assist the monitoring. For these purposes, the jumper app may display various buttons to be clicked when needed. For example, the log file may be used to identify the time a communication with the jumper 18 broke down and where the mobile device 22 was located at that time. This provides information about where the jumper 18 was last “seen.” In another example, the mobile device 22 may cause (e. g., by emitting a polling signal) any ID device 26 within radio range to vibrate or to emit a sound. The technician 20 can then follow the sound and find the jumper 18. According to another function the mobile device 22 can generate and display a warning message if the jumper 18 and the mobile device are too far apart and the communication breaks down. The jumper app may also viewing a history of the jumper's use over time.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A monitoring system, comprising:
a wire bridge adapted for use by a technician during servicing an electrical or electro-mechanical installation to bridge a component of the installation, wherein the wire bridge includes an electronic identification device for transmitting a radio signal including an identification number of the wire bridge; and
a monitoring device for monitoring use of the wire bridge, the monitoring device having:
a transceiver for receiving the radio signal transmitted by the electronic identification device when within a predetermined radio range of the electronic identification device,
a memory for recording use of the wire bridge, and
a processor for monitoring if the wire bridge is within the predetermined radio range, and for generating an alarm if the wire bridge is not within the predetermined radio range and the wire bridge is recorded in the memory as being in use.

17. The system according to claim 16 wherein the memory stores usage data of the wire bridge, wherein the usage data includes at least one of the identification number, a location of where the wire bridge is used, date and time of use of the wire bride, and a location of the monitoring device.

18. The system according to claim 16 wherein the electronic identification device and the transceiver each includes a wireless communications device.

19. The system according to claim 16 wherein the electronic identification device includes an RFID tag and the transceiver includes an RFID reader, or wherein the electronic identification device includes a Bluetooth beacon and the transceiver includes a Bluetooth module.

20. The system according to claim 16 including a housing having a compartment adapted to receive the wire bridge and wherein the transceiver is mounted in the compartment.

21. The system according to claim 20 wherein the housing includes a power supply providing electrical power to the transceiver.

22. The system according to claim 16 including a log server having a database recording use of the wire bridge in response to a message received from the transceiver, wherein the message includes the identification number.

23. The system according to claim 22 including a control center and wherein the control center, the log server and the transceiver communicate via a network.

24. The system according to claim 16 wherein the monitoring device is an electronic mobile device.

25. The system according to claim 24 wherein the electronic mobile device is one of a smartphone, a tablet computer and a portable computer.

26. A method of monitoring use of a wire bridge, comprising the steps of:
receiving a radio signal including an identification number of the wire bridge from the wire bridge when within a predetermined radio range of the wire bridge;
based on the received radio signal, recording that the wire bridge is being used by a technician during servicing of an electrical or electro-mechanical installation;
monitoring the radio signal to determine if the wire bridge is still within the predetermined radio range; and
generating an alarm if the wire bridge is not within the predetermined radio range and the wire bridge is recorded as being in use, wherein the alarm is communicated to the technician using a monitoring device assigned to the technician.

27. The method according to claim 26 including recording use of the wire bridge in a memory, wherein the recording use includes storing usage data comprising at least one of the identification number, a location of where the wire bridge is being used, date and time of use of the wire bridge, and a location of the monitoring device.

28. The method according to claim 27 including recording the usage data in a log server.

29. The method according to claim 26 wherein generating the alarm includes generating at least one of a warning message, a visible alarm, an audible alarm and a vibrational alarm.

30. The method according to claim 26 including sending a report message to a control center, wherein the report message includes data about the generated alarm and use of the wire bridge.

31. The method according to claim 30 including determining at the control center if a confirmation of the alarm is received from the monitoring device, wherein the confirmation is indicative of an action taken in response to the alarm.
